(19) United States
(12) Patent Application Publication
(10) Pub. No.: US 2017/0307786 A1
(43) Pub. Date: Oct. 26, 2017

(54) ARTICLE WITH HARDCOAT AND METHOD OF MAKING THE SAME

(71) Applicant: 3M INNOVATIVE PROPERTIES COMPANY, St. Paul, MN (US)

(72) Inventors: Naota Sugiyama, Tokyo (JP); Chikara Abe, Yamagata (JP); Richard J. Pokorny, Maplewood, MN (US); Kristy A. Gillette, Spring Valley, WI (US)

(21) Appl. No.: 15/528,796

(22) PCT Filed: Dec. 1, 2015
(86) PCT No.: PCT/US2015/063124

§ 371 Date: May 23, 2017

Related U.S. Application Data
(60) Provisional application No. 62/091,846, filed on Dec. 15, 2014.

(51) Int. Cl. G02B 1/14; C09D 4/00; C09D 7/12; G02B 5/30; G02F 1/1335; C08K 9/04; C08K 3/36

(52) U.S. Cl. CPC G02B 1/14; C09D 7/1225; C09D 4/00; C09D 7/1266; G02B 5/3041; G02B 5/3066; C08K 2201/003; C08K 9/04; C08K 3/36; G02F 1/133536

(57) ABSTRACT

Article comprising a reflective polarizer having a first major surface, and an exposed hardcoat on the first major surface, the hardcoat comprising binder, wherein the hardcoat has a thickness less than 500 nanometers and has a scratch rating of not greater than 1 as determined by the Linear Abrasion Test in the Examples. Articles described herein are useful, for example, for applications benefiting from reflective polarizers having brightness enhancement properties (e.g., use with liquid crystal display (LCD) devices).

### CROSS REFERENCE TO RELATED APPLICATION

This application claims the benefit of U.S. Provisional Patent Application No. 62/091,846, filed Dec. 15, 2014, the disclosure of which is incorporated by reference herein in its entirety.

### BACKGROUND

Reflective polarizer films are often used in liquid crystal display (LCD) devices to increase brightness. For example, the reflective polarizer film can be laminated with a rear polarizer film.

Desirably, the reflective polarizer film is sufficiently scratch resistance to prevent scratches produced by touching with a prism film which is typically used under the reflective polarizer film. Therefore, a hard coat is typically applied on the bottom surface of the reflective polarizer film to be protected from any scratches.

Also, desirably there is sufficient peel strength between the reflective polarizer film and hard coat for product converting processes. It is also desirable to have a relatively thin product thickness, for example, for devices such as mobile phones and tablets.

Additional reflective polarizer assemblies are desired.

### SUMMARY

In one aspect, the present disclosure describes an article comprising:

a reflective polarizer having a first major surface; and

exposed hardcoat on the first major surface, the exposed hardcoat comprising binder, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 percent surfactant, based on the total weight of the binder including the surfactant), and wherein the exposed hardcoat has a thickness not greater than 500 nanometers (in some embodiments, not greater than 450 nanometers, 400 nanometers, 350 nanometers, 300 nanometers, 250 nanometers, or even not greater than 200 nanometers; in some embodiments, in a range from 200 nanometers to 500 nanometers, 200 nanometers to 400 nanometers, or even 200 nanometers to 300 nanometers) and has a scratch rating of not greater than 1 as determined by the Linear Abrasion Test in the Examples.

In another aspect, the present disclosure describes a method of making an article described herein, the method comprising:
providing a reflective polarizer having a first major surface;
coating a mixture onto the first major surface, the mixture comprising at least one of acrylic, (meth)acrylic oligomer, or monomer binder in a range from 5 weight percent to 60 weight percent, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant), and nanoparticles in a range from 40 to 95 (in some embodiments, in a range from 30 to 85) weight percent, based on the total weight of the mixture, and wherein the nanoparticles have an average particle diameter in a range from 2 nm to 100 nm; and
curing the at least one of acrylic, (meth)acrylic oligomer, or monomer binder to provide the article.

In another aspect, the present disclosure describes a method of making an article described herein, the method comprising:
providing a reflective polarizer having a first major surface;
coating at least one of acrylic, (meth)acrylic oligomer, or monomer binder onto the major surface, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant); and
curing the at least one of acrylic, (meth)acrylic oligomer, or monomer binder to provide the article.

Articles described herein are useful, for example, for applications benefiting from reflective polarizers having brightness enhancement properties (e.g., use with liquid crystal display (LCD) devices).

### DETAILED DESCRIPTION

Exemplary binders include acrylics (e.g., silicone acrylate), (meth)acrylic oligomers, or monomers (e.g., a fluoroacrylate), and are commercially available, for example, from Arkema Group, Clear Lake, Tex., under the trade designation “SARTOMER.” Exemplary surfactants include those available under the trade designations “KY1203” from Shin-Etsu Chemical Co., Tokyo, Japan, and “TEGORAD 2500” from Evonik Industries AG, Mobile, Ala.

In some embodiments, the exposed hardcoat further comprises nanoparticles in a range from 40 to 95 (in some embodiments, in a range from 30 to 85) weight percent, based on the total weight of the exposed hardcoat, and wherein the nanoparticles have an average particle diameter in a range from 2 nm to 100 nm.

In some embodiments, the ratio of average particle diameters of nanoparticles having an average particle diameter in the range from 2 nm to 20 nm to average particle diameters of nanoparticles having an average particle diameter in the range from 20 nm to 100 nm is in a range from 1:2 to 1:200.

Exemplary nanoparticles include SiO₂, ZrO₂, or Sb doped SnO₂ nanoparticles. SiO₂ nanoparticles are commercially available, for example, from Nissan Chemical Industries, Ltd., Tokyo, Japan; C. I. Kasei Company, Limited, Tokyo, Japan; and Nalco Company, Naperville, Ill. ZrO₂, nanoparticles are commercially available, for example, from Nissan Chemical Industries. Sb doped SnO nanoparticles are commercially available, for example, from Advanced Nanoproducts, Sejong-si, South Korea.

Exemplary nanoparticles include SiO₂ or ZrO₂ nanoparticles. The nanoparticles can consist essentially of, or consist of, a single oxide such as silica, or can comprise a combination of oxides, or a core of an oxide of one type (or a core of a material other than a metal oxide) on which is deposited an oxide of another type. The nanoparticles are often provided in the form of a sol containing a colloidal dispersion of inorganic oxide particles in liquid media. The sol can be prepared using a variety of techniques and in a variety of forms including hydrosols (where water serves as the liquid medium), organosols (where organic liquids so serve), and mixed sols (where the liquid medium contains both water and an organic liquid).

Aqueous colloidal silicas dispersions are commercially available, for example, from Nalco Chemical Co., Naperville, Ill., under the trade designation “NALCO COLLODIAL SILICAS” such as products 1040, 1042, 1050, 1060, 2327, 2329, and 2329K or Nissan Chemical America Corporation, Houston, Tex., under the trade designation “SNOWTEX.” Organic dispersions of colloidal silicas are commercially available, for example, from Nissan Chemical under the trade designation “ORGANOSILICASOL.” Suitable fumed silicas include products commercially available, for example, from Evonik DeGussa Corp., Parsippany, N.J., under the trade designation, “AEROSIL SERIES OX-50,” as well as product numbers -130, -150, and -200. Fumed silicas are also commercially available, for example, from Cabot Corp., Tuscola, Ill., under the trade designations “CAB-O-SPERSE 2095,” “CAB-O-SPERSE A105,” and “CAB-O-SIL M5.”

It may be desirable to employ a mixture of oxide particle types to optimize an optical property, material property, or to lower the total composition cost.

In some embodiments, the hardcoat may comprise various high refractive index inorganic nanoparticles. Such nanoparticles have a refractive index of at least 1.60, 1.65, 1.70, 1.75, 1.80, 1.85, 1.90, 1.95, 2.00, or higher. High refractive index inorganic nanoparticles include zirconia (ZrO₂), titania (TiO₂), antimony oxides, alumina, tin oxides, alone or in combination. Mixed metal oxides may also be employed.

Zirconias for use in the high refractive index layer are available, for example, from Nalco Chemical Co., under the trade designation “NALCO OOSSOO8,” Buhler AG, Uzwil, Switzerland, under the trade designation “BUHLER ZIRCONIA Z-WO SOL” and Nissan Chemical America Corporation, under the trade designation “NANOUSE ZR.” Zirconia nanoparticles can also be prepared such as described, for example, in U.S. Pat. No. 7,241,437 (Davidson et al.) and U.S. Pat. No. 6,376,590 (Kolb et al.). A nanoparticle dispersion that comprises a mixture of tin oxide and zirconia covered by antimony oxide (RI˜1.9) is commercially available, for example, from Nissan Chemical America Corporation, under the trade designation “HX-05M5.” A tin oxide nanoparticle dispersion (RI ˜2.0) is commercially available, for example, from Nissan Chemicals Corp., under the trade designation “CX-S401M.”

Reflective polarizers are known in the art. Reflective polarizers typically reflect light having one polarization and transmit light having an orthogonal polarization. Reflective polarizers often have incomplete reflectivity of the high extinction polarization over a wavelength region of interest. Typically, the reflectivity is greater than 50% and is often greater than 90% or even greater than 95%. A reflective polarizer also typically has some absorption of light having the high transmission polarization (e.g., absorption is less than about 5 to 15%).

In some embodiments, a reflective polarizer is made of alternating layers (ABABA . . . ) of two different polymeric materials, referred to here as material “(A)” and material “(B).” The two materials are extruded together and the resulting multiple layer (ABABA . . . ) material is stretched (5:1) along one axis (X), and is not stretched appreciably (1:1) along the other, orthogonal axis (Y). The X axis is referred to as the “stretched” direction while the Y axis is referred to as the “transverse” direction.

The (B) material has a nominal index of refraction (n=1.64 for example) which is not substantially altered by the stretching process.

The (A) material has the property of having the index of refraction altered by the stretching process. For example, a uniaxially stretched sheet of the (A) material will have one index of refraction (n=1.88 for example) associated with the stretched direction and a different index of refraction (n=1.64 for example) associated with the transverse direction. By way of definition, the index of refraction associated with an in-plane axis (an axis parallel to the surface of the film) is the effective index of refraction for plane-polarized incident light whose plane of polarization is parallel to that axis.

Thus, after stretching the multiple layer stack (ABABA . . . ) of material shows a large refractive index difference between layers (delta n=1.88 1.64=0.24) associated with the stretched direction. While in the transverse direction, the associated indices of refraction between layers are essentially the same (delta n=1.64−1.64=0.0). These optical characteristics cause the multiple layer laminate to act as a reflecting polarizer that will transmit the polarization component of the incident light that is correctly oriented with respect to a transmission axis. The light which emerges from the reflective polarizer is referred to as having a first polarization orientation (a).

The light that does not pass through the reflective polarizer has a polarization orientation (b) that differs from the first orientation (a). Light exhibiting this polarization orientation (b) will encounter the index differences which result in reflection of this light. This defines a so-called “extinction” axis. In this fashion the reflective polarizer transmits light having a selected polarization (a) and reflects light having the polarization (b).

Although an embodiment of the reflective polarizer has been discussed with an exemplary multiple layer construction which includes alternating layers of only two materials it should be understood that the reflective polarizer may take a number of forms. For example, additional types of layers may be included into the multiple layer construction. Also in a limiting case, the reflective polarizer may include a single pair of layers (AB) one of which is stretched.

One of ordinary skill will readily appreciate that a wide variety of materials can be used to form multilayer reflective polarizers when processed under conditions selected to yield the desired refractive index relationships. The desired refractive index relationships can be achieved in a variety of ways, including stretching during or after film formation (e.g., in the case of organic polymers), extruding (e.g., in the case of liquid crystalline materials), or coating. In addition, it is preferred that the two materials have similar rheological properties (e.g., melt viscosities) such that they can be co-extruded.

Specific examples of suitable materials include polyethylene naphthalate (PEN) and isomers thereof (e.g., 2,6-, 1,4-, 1,5-, 2,7-, and 2,3-PEN), polyalkylene terephthalates (e.g., polyethylene terephthalate, polybutylene terephthalate, and poly-1,4-cyclohexanedimethylene terephthalate), polyimides (e.g., polyacrylic imides), polyetherimides, atactic polystyrene, polycarbonates, polymethacrylates (e.g., polyisobutyl methacrylate, polypropylmethacrylate, polyethylmethacrylate, and polymethylmethacrylate), polyacrylates (e.g., polybutylacrylate and polymethylacrylate), syndiotactic polystyrene (sPS), syndiotactic poly-alpha-methyl styrene, syndiotactic polydichlorostyrene, copolymers and blends of any of these polystyrenes, cellulose derivatives (e.g., ethyl cellulose, cellulose acetate, cellulose propionate, cellulose acetate butyrate, and cellulose nitrate), polyalkylene polymers (e.g., polyethylene, polypropylene, polybutylene, polyisobutylene, and poly(4-methyl)pentene), fluorinated polymers (e.g., perfluoroalkoxy resins, polytetrafluoroethylene, fluorinated ethylene-propylene copolymers, polyvinylidene fluoride, and polychlorotrifluoroethylene), chlorinated polymers (e.g., polyvinylidene chloride and polyvinylchloride), polysulfones, polyethersulfones, polyacrylonitrile, polyamides, silicone resins, epoxy resins, polyvinylacetate, polyether-amides, ionomeric resins, elastomers (e.g., polybutadiene, polyisoprene, and neoprene), and polyurethanes. Also suitable are copolymers, e.g., copolymers of PEN (e.g., copolymers of 2,6-, 1,4-, 1,5-, 2,7-, and/or 2,3-naphthalene dicarboxylic acid, or esters thereof, with (a) terephthalic acid, or esters thereof; (b) isophthalic acid, or esters thereof; (c) phthalic acid, or esters thereof; (d) alkane glycols; (e) cycloalkane glycols (e.g., cyclohexane dimethanol diol); (f) alkane dicarboxylic acids; and/or (g) cycloalkane dicarboxylic acids (e.g., cyclohexane dicarboxylic acid)), copolymers of polyalkylene terephthalates (e.g., copolymers of terephthalic acid, or esters thereof, with (a) naphthalene dicarboxylic acid, or esters thereof; (b) isophthalic acid, or esters thereof; (c) phthalic acid, or esters thereof; (d) alkane glycols; (e) cycloalkane glycols (e.g., cyclohexane dimethanol diol); (f) alkane dicarboxylic acids; and/or (g) cycloalkane dicarboxylic acids (e.g., cyclohexane dicarboxylic acid)), and styrene copolymers (e.g., styrene-butadiene copolymers and styrene-acrylonitrile copolymers), 4,4′-bibenzoic acid and ethylene glycol. In addition, each individual layer may include blends of two or more of the above-described polymers or copolymers (e.g., blends of SPS and atactic polystyrene). The coPEN described may also be a blend of pellets where at least one component is a polymer based on naphthalene dicarboxylic acid and other components are other polyesters or polycarbonates, such as a PET, a PEN or a co-PEN.

In some embodiments, particularly combinations of layers in the case of polarizers include PEN/co-PEN, polyethylene terephthalate (PET)/co-PEN, PEN/sPS, PET/sPS, PEN/copolyester, and PET/copolyester, where “co-PEN” refers to a copolymer or blend based upon naphthalene dicarboxylic acid (as described above) and copolyester is polycyclohexanedimethylene terephthalate (available, for example, under the trade designation “EASTAR” from Eastman Chemical Co., Kingsport, Tenn.).

The number of layers in the device is selected to achieve the desired optical properties using the minimum number of layers for reasons of film thickness, flexibility and economy. In the case of reflective polarizers, the number of layers is preferably less than 10,000 (in some embodiments, less than 5,000, or even less than 2,000).

As discussed above, the ability to achieve the desired relationships among the various indices of refraction (and thus the optical properties of the multilayer device) is influenced by the processing conditions used to prepare the multilayer device. In the case of organic polymers which can be oriented by stretching, the devices are generally prepared by co-extruding the individual polymers to form a multilayer film and then orienting the film by stretching at a selected temperature, optionally followed by heat-setting at a selected temperature. Alternatively, the extrusion and orientation steps may be performed simultaneously. In the case of polarizers, the film is stretched substantially in one direction (uniaxial orientation), while in the case of mirrors the film is stretched substantially in two directions (biaxial orientation). Additional details regarding reflective polarizers and various methods for making and using reflective polarizers can be found, for example, in U.S. Pat. No. 5,828,488 (Ouderkirk et al.), the disclosure of which is incorporated herein by reference.

Various functional layers or coatings may be added to the optical films and devices of the present invention to alter or improve their physical or chemical properties, particularly along the surface of the film or device. Such layers or coatings may include, for example, slip agents, low adhesion backside materials, conductive layers, antistatic coatings or films, barrier layers, flame retardants, UV stabilizers, abrasion resistant materials, optical coatings, compensation films, retardation films, diffuse adhesives, and/or substrates designed to improve the mechanical integrity or strength of the film or device.

Skin layers or coatings may also be added to impart desired barrier properties to the resulting film or device. Thus, for example, barrier films or coatings may be added as skin layers, or as a component in skin layers, to alter the transmissive properties of the film or device towards liquids, such as water or organic solvents, or gases, such as oxygen or carbon dioxide.

Skin layers or coatings may also be added to impart or improve abrasion resistance in the resulting article. Thus, for example, a skin layer comprising particles of silica embedded in a polymer matrix may be added to an optical film produced in accordance with the invention to impart abrasion resistance to the film, provided, of course, that such a layer does not unduly compromise the optical properties required for the application to which the film is directed.

Skin layers or coatings may also be added to impart or improve puncture and/or tear resistance in the resulting article. Factors to be considered in selecting a material for a tear resistant layer include percent elongation to break, Young's modulus, tear strength, adhesion to interior layers, percent transmittance and absorbance in an electromagnetic bandwidth of interest, optical clarity or haze, refractive indices as a function of frequency, texture and roughness, melt thermal stability, molecular weight distribution, melt rheology and coextrudability, miscibility and rate of inter-diffusion between materials in the skin and optical layers, viscoelastic response, relaxation and crystallization behavior under draw conditions, thermal stability at use temperatures, weatherability, ability to adhere to coatings and permeability to various gases and solvents. Puncture or tear resistant skin layers may be applied during the manufacturing process or later coated onto or laminated to the multilayer optical film. Adhering these layers to the film during the manufacturing process, such as by a coextrusion process, provides the advantage that the film is protected during the manufacturing process. In some embodiments, one or more puncture or tear resistant layers may be provided within the film, either alone or in combination with a puncture or tear resistant skin layer.

In some embodiments, articles described herein further comprise an absorbing polarizer, wherein, in order are, the absorbing polarizer, the reflective polarizer; and the exposed hardcoat. In some embodiments, articles described herein further comprise pressure sensitive adhesive and an absorbing polarizer, wherein, in order are, the absorbing polarizer, the pressure sensitive adhesive, the reflective polarizer, and the exposed hardcoat.

Exemplary absorbing polarizers include dichroic polarizers (e.g., dichroic polarizing films). Dichroic polarizers typically absorb light in the non-transmission polarization. However, dichroic polarizers also absorb some of the light having the high transmission polarization. The amount of this absorption depends on the details of the construction of the polarizer and the designed extinction ratio. For high performance display polarizers, such as those used in liquid crystal displays, this absorption loss is typically in a range from about 5% to about 15%. The reflectivity of these polarizers for light having the absorption (i.e., low transmission) polarization tends to be small. Even with surface reflections included, this reflectivity is typically less than 10%, and usually less than 5%.

Dichroic polarizer are known in the art, and include a polyvinyl alcohol (PVA) film with a dye material incorporated therein, made, for example, where the polyvinyl alcohol film is stretched to orient the film and then stained with the dye material. The orientation of the film determines the optical properties (e.g., the axis of extinction) of the film.

The film may be made by a variety of techniques. One exemplary method for making the film includes mixing the polyvinyl alcohol in a solvent, typically, water, to form a solution with about 5 to 30% solids. The solution is then applied to a substrate and dried at a temperature in a range from about 100° C. to about 120° C. The film is stretched to orient the polyvinyl alcohol.

Some embodiments of such polyvinyl alcohol dichroic polarizers include a second polymer that is dispersible or soluble in the solvent used in the formation of the polyvinyl alcohol film, where the additional polymer significantly reduces cracking and improves adhesion of the dichroic polymer to a substrate. The second polymer can be included as either a dispersion or a solution, depending on the nature of the second polymer, where the terms “dispersion” and “solution” will be used interchangeably herein. In some embodiments, the second polymer is water-soluble as water is a common solvent for polyvinyl alcohol. In some embodiments, the second polymer is a polar polymer. Exemplary second polymers include polyvinyl pyrrolidone and polyesters soluble or dispersible in the solvent of the polyvinyl alcohol. Examples of water-soluble or water dispersible polyesters include sulfonated polyesters, such as those describe in U.S. Pat. No. 5,427,835 (Morrison et al.), the disclosure of which is incorporated herein by reference. Exemplary co-solvents include polar solvents such as C1-C4 alcohols.

In some embodiments, the polyvinyl alcohol and second polymer are mixed in a ratio in a range from 5:1 to 100:1 by weight (in some embodiments, in a range from 8:1 to 20:1 by weight. In some embodiments, the solution is 1 to 50 wt. % solids (in some embodiments, in a range from 5 to 25 wt. % solids).

The polyvinyl alcohol film may be made by a variety of techniques known in the art, including combining the polyvinyl alcohol and the second polymer in a solvent. This dispersion/solution of the two polymers is then applied to the surface of a substrate. The substrate may be, for example, another film, a multilayer stack, a plastic object, or any other surface which allows stretching of the polyvinyl alcohol film. Application of the dispersion/solution may be accomplished, for example, by a variety of known methods, including coating the substrate using techniques such as shoe coating, extrusion coating, roll coating, curtain coating, or any other coating method capable of providing a uniform coating. The substrate may be coated with a primer or an adhesive or the substrate may be treated with a corona discharge to help anchor the polyvinyl alcohol film to the substrate. In some embodiments, the thickness of the coating is in a range from 25 micrometers to 500 micrometers when wet (in some embodiments, in a range from 25 micrometers to 125 micrometers). After coating, the polyvinyl alcohol film can be dried at a temperature typically in a range from 100° C. to 150° C. The film can then stretched using, for example, using length orienters or tenter clips to orient the film. In some embodiments, the film is removed from the substrate. The film may then be adhered to another surface, if desired. The polyvinyl alcohol film can then be used as a dichroic polarizer when stained.

Exemplary dichroic dye material may include dyes and pigments. Exemplary dye materials for use in the dichroic polarizer film include iodine, as well as anthraquinone and azo dyes, such as Congo Red (sodium diphenyl-bis-.alpha.-naphthylamine sulfonate), methylene blue, stilbene dye (Color Index (CI)=620), and 1,1′-diethyl-2,2′-cyanine chloride (CI=374 (orange) or CI=518 (blue)). The properties of these dyes, and methods of making them, are described, for example, in E. H. Land, Colloid Chemistry (1946). Still other dichroic dyes, and methods of making them, are discussed, for example, in the Kirk Othmer Encyclopedia of Chemical Technology, Vol. 8, pp. 652-661 (4th Ed. 1993), and in the references cited therein.

The dichroic dye material may be added to the dispersion of the polyvinyl alcohol and second polymer prior to coating. Alternatively, for example, a polyvinyl alcohol film may be stained with a staining composition, such as, for example, an iodine-containing solution. The staining of the polyvinyl alcohol film may occur before or after the film is drawn. In some embodiments, the dichroic dye material may not be able to withstand the drawing conditions and should therefore be applied to the polyvinyl alcohol film after drawing.

In some embodiments a staining composition is an iodine-containing solution. The iodine stained film may be stabilized, for example, using a boron-containing composition, such as a boric acid/borax solution. Other stains may benefit from different stabilizers. The concentrations of the staining or stabilizing compositions, as well as the temperature at which the staining or stabilization occurs and the time of contact with each solution, may vary widely without compromising the stain.

Various other components may be added to the solution of polyvinyl alcohol and the second polymer. For example, a surfactant may be added to facilitate wetting of the substrate. A wide variety of surfactants may be used, including that available under the trade designation “TRITON X-100” from Union Carbide Chemicals and Plastics Company, Inc., Danbury, Conn. The surfactant is typically about 1% or less of the solution (in some embodiments, about 0.5% or less). In some embodiments, the surfactant is nonionic so that it does not interfere with polar groups on the polymer.

In some embodiments, a drying aid (e.g., N-methyl-pyrrolidone or butyl carbitol) is added to facilitate film formation on drying. The drying aid is typically about 10% or less of the solution (in some embodiments, about 5% or less).

Additional details on absorbing polarizers may be found, for example, in PCT Pub. No. WO 2014/0130283 (Haag et al.), published Aug. 28, 2014, the disclosure of which is incorporated herein by reference.

In some embodiments, the reflective polarizer comprises a plurality of film layers, and where at least a portion of the film layers have a peel force-between adjacent film layers of at least 0.2 Newton/25 mm as determined by the Peel Test in the Examples.

Pressure sensitive adhesives are known in the art and are normally tacky at room temperature and can be adhered to a surface by application of, at most, light finger pressure, while non-pressure sensitive adhesives include solvent, heat, or radiation activated adhesive systems. Exemplary pressure sensitive adhesives include those based on general compositions of polyacrylate; polyvinyl ether; diene-containing rubbers such as natural rubber, polyisoprene, and polyisobutylene; polychloroprene; butyl rubber; butadiene-acrylonitrile polymers; thermoplastic elastomers; block copolymers such as styrene-isoprene and styrene-isoprene-styrene block copolymers, ethylene-propylene-diene polymers, and styrene-butadiene polymers; polyalphaolefins; amorphous polyolefins; silicone; ethylene-containing copolymers such as ethylene vinyl acetate, ethylacrylate, and ethylmethacrylate; polyurethanes; polyamides; polyesters; epoxies; polyvinylpyrrolidone and vinylpyrrolidone copolymers; and mixtures of the above.

In some embodiments, pressure sensitive adhesives can contain additives such as tackifiers, plasticizers, fillers, antioxidants, stabilizers, pigments, diffusing particles, curatives, and solvents. The particular adhesive composition and thickness used are preferably selected so as not to significantly interfere with the optical properties of the optical film.

In some embodiments, articles described herein further comprise a primer layer between the reflective polarizer and the exposed hardcoat. Exemplary primers include polyvinylidene chloride and cross-linked acrylic polymers. Techniques for applying the primer layer are known in the art, and include roll coating, gravure coating, and wire wound rod coating.

In one exemplary method, exemplary articles described herein can be made by a method comprising:
providing a reflective polarizer having a first major surface;
coating a mixture onto the first major surface, the mixture comprising at least one of acrylic, (meth)acrylic oligomer, or monomer binder in a range from 5 weight percent to 60 weight percent, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant), and nanoparticles in a range from 40 to 95 (in some embodiments, in a range from 30 to 85) weight percent, based on the total weight of the mixture, and wherein the nanoparticles have an average particle diameter in a range from 2 nm to 100 nm; and
curing (e.g., actinic radiation (e.g., ultraviolet or e-beam)) at least one of the acrylic, (meth)acrylic oligomer, or monomer binder to provide the article.

In one exemplary method, exemplary articles described herein can be made by a method comprising:
providing a reflective polarizer having a first major surface;
coating at least one of acrylic, (meth)acrylic oligomer, or monomer binder onto the major surface, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant); and
curing (e.g., actinic radiation (e.g., ultraviolet or e-beam)) the at least one of acrylic, (meth)acrylic oligomer, or monomer binder to provide the article. In some embodiments, coating the monomer binder onto the major surface is done via vapor deposition of the monomer.

In some embodiments, exposed hardcoats described herein have a thickness not greater than 500 nanometers (in some embodiments, not greater than 450 nanometers, 400 nanometers, 350 nanometers, 300 nanometers, 250 nanometers, or even not greater than 200 nanometers; in some embodiments, in a range from 200 nanometers to 500 nanometers, 200 nanometers to 400 nanometers, or even 200 nanometers to 300 nanometers).

Articles described herein are useful, for example, for applications benefiting from reflective polarizers having brightness enhancement properties (e.g., use with liquid crystal display (LCD) devices).

### Exemplary Embodiments

1A. An article comprising:
a reflective polarizer having a first major surface; and exposed hardcoat on the first major surface, the exposed hardcoat comprising binder, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant), and wherein the exposed hardcoat has a thickness not greater than 500 nanometers (in some embodiments, not greater than 450 nanometers, 400 nanometers, 350 nanometers, 300 nanometers, 250 nanometers, or even not greater than 200 nanometers; in some embodiments, in a range from 200 nanometers to 500 nanometers, 200 nanometers to 400 nanometers, or even 200 nanometers to 300 nanometers) and has a scratch rating of not greater than 1 as determined by the Linear Abrasion Test in the Examples.
   2A. The article of Exemplary Embodiment 1A, wherein the exposed hardcoat further comprises nanoparticles in a range from 40 to 95 (in some embodiments, in a range from 30 to 85) weight percent, based on the total weight of the exposed hardcoat, and wherein the nanoparticles have an average particle diameter in a range from 2 nm to 100 nm.
   3A. The article of Exemplary Embodiment 2A, wherein the ratio of average particle diameters of nanoparticles having an average particle diameter in the range from 2 nm to 20 nm to average particle diameters of nanoparticles having an average particle diameter in the range from 20 nm to 100 nm is in a range from 1:2 to 1:200.
   4A. The article of either Exemplary Embodiment 2A or 3A, wherein the nanoparticles include at least one of SiO₂, ZrO₂, or Sb doped SnO₂ nanoparticles.
   5A. The article of any of Exemplary Embodiments 2A to 4A, wherein the nanoparticles include modified nanoparticles.
   6A. The article of any preceding A Exemplary Embodiment, wherein the binder comprises cured acrylate.
   7A. The article of any preceding A Exemplary Embodiment further comprising an absorbing polarizer, wherein, in order are, the absorbing polarizer, the reflective polarizer; and the exposed hardcoat.
   8A. The article of any of Exemplary Embodiments 1A to 6A further comprising pressure sensitive adhesive and an absorbing polarizer, wherein, in order are, the absorbing polarizer, the pressure sensitive adhesive, the reflective polarizer, and the exposed hardcoat.
   9A. The article according to either Exemplary Embodiment 7A or 8A, further comprising a primer layer between the reflective polarizer and the exposed hardcoat.
   10A. The article according to any of preceding A Exemplary Embodiment, wherein the reflective polarizer comprises a plurality of film layers, and where at least a portion of the film layers have a peel force between adjacent film layers of at least 0.2 Newton/25 mm as determined by the Peel Test in the Examples.
   1B. A method of making the article of any of Exemplary Embodiments 2A to 10A comprising nanoparticles, the method comprising:
providing a reflective polarizer having a first major surface;
coating a mixture onto the first major surface, the mixture comprising at least one of acrylic, (meth)acrylic oligomer, or monomer binder in a range from 5 weight percent to 60 weight percent, wherein the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant), and nanoparticles in a range from 40 to 95 (in some embodiments, in a range from 30 to 85) weight percent, based on the total volume of the mixture, and wherein the nanoparticles have an average particle diameter in a range from 2 nm to 100 nm; and
curing the at least one of acrylic, (meth)acrylic oligomer, or monomer binder to provide the article.
   2B. The method of Exemplary Embodiment 1B, wherein the curing includes actinic radiation (e.g., ultraviolet or e-beam).
   3B. A method of making the article of any of Exemplary Embodiments 1A or 6A to 10A not including nanoparticles, the method comprising:
providing a reflective polarizer having a first major surface;
coating at least one of acrylic, (meth)acrylic oligomer, or monomer binder onto the major surface, wherein the binder comprises surfactant (in some embodiments the binder comprises surfactant (in some embodiments the binder comprises less than 2, 5, 6, 7, 8, 9, 10, 15, 20, or even less than 25 weight percent surfactant; in some embodiments in a range from 0 to 10, or even from 2 to 25 weight percent surfactant, based on the total weight of the binder including the surfactant)); and
curing the at least one of acrylic, (meth)acrylic oligomer, or monomer binder to provide the article.
   4B. The method of Exemplary Embodiment 3B, wherein the curing includes actinic radiation (e.g., ultraviolet or e-beam).

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Materials

| Chemical | Description | Source |
|---|---|---|
| “A-174” | 3-methacryloxypropyl- | obtained from Alfa Aesar, Ward Hill, MA, |
| | trimethoxysilane | under trade designation “SILQUEST A-174” |
| “PROSTAB” | 4-hydroxy-2,2,6,6- | obtained from Aldrich Chemical Company, |
| | tetramethylpiperidine 1- | Milwaukee, WI, under trade designation |
| | oxyl (5 wt. %) | “PROSTAB” |
| “NALCO 2327” | 20 nm diameter SiO₂ sol | obtained from Nalco Company, Naperville, |
| | | IL, under trade designation “NALCO 2327” |
| “NALCO 2329” | 75 nm diameter SiO₂ sol | obtained from Nalco Company, Naperville, |
| | | IL, under trade designation “NALCO 2329” |
| “EBECRYL 8301” | hexafunctional aliphatic | obtained from Daicel-Allnex, Ltd., Tokyo, |
| | urethane acrylate | Japan, under trade designation “EBECRYL |
| | | 8301” |
| “SR368” | tris (2-hydroxy ethyl) | obtained from Arkema Group, Clear Lake, |
| | isocyanurate triacrylate | TX, under trade designation “SARTOMER |
| | | SR368” |
| “ESACURE ONE” | difunctional alpha | obtained from Lamberti, Gallarate, Italy, |
| | hydroxyketone | under trade designation “ESACURE ONE” |
| “TEGORAD 2500” | leveling agent | obtained from Evonik Industries AG, Mobile, |
| | | AL, under trade designation “TEGORAD |
| | | 2250” |
| 1-methoxy-2-propanol | Solvent | obtained from Aldrich Chemical Company, |
| | | Milwaukee, Wisconsin |
| 2-propanol | Solvent | obtained from Aldrich Chemical Company, |
| | | Milwaukee, Wisconsin |

### Test Methods

### Method for Determining Adhesion Performance (Peel Force Measurement; “Peel Test”)

Adhesion performance of the samples prepared according to the Examples and Comparative Examples was evaluated using a peel tester (obtained under the trade designation “I-MASS” from IMass, Inc., Accord, Mass.). For the test 25 mm×250 mm cuts were made on the samples from the hardcoat side. In one mode of the test, the cuts were “shallow,” meaning that the cuts went through the hardcoat but did not cut the substrate. On a second mode, the cuts were “deep” meaning that the cuts reached the substrate but did not cut through the substrate. The sample was attached to the test platen using a double stick tape (obtained under the trade designation “3M SPLICING TAPE 415” from 3M Company, Saint Paul, Minn.) from the substrate (i.e., the reflective polarizer) side. A tape (obtained under the trade designation “NICHIBAN CT24” from Nitto Denko CO., LTD, Osaka, Japan) was then placed over the hardcoat side over the cut area. Then, the tape attached to the hardcoat side was lifted at 90 degree angle at a rate of 60 inches/min. (1.52 m/min.). The presence/absence of delamination was observed in the case of shallow cuts. The peel force was measured in the case of deep cuts and the data is reported as (N/cm).

### Method for Determining Steel Wool Abrasion Resistance

The scratch resistance of the samples prepared according to the Examples and Comparative Examples was evaluated by the surface changes after the steel wool abrasion test using 10 mm square #0000 steel wool after 10 cycles at 0.98N load and at 60 cycles/min. rate. The strokes were 85 mm long. The instrument used for the test was an abrasion tester (obtained under the trade designation “IMC-157C” from Imoto Machinery Co., LTD, Kyoto, Japan). After the steel wool abrasion resistance test was completed, the samples were observed for the presence of scratches and rated as shown in Table 1, below.

TABLE 1

| Observation | Rating |
|---|---|
| No scratches | 0 |
| A few very faint scratches only | 1 |
| observed in reflection | |
| Several faint scratches | 2 |
| Several faint, few deep scratches | 3 |
| Large number of deep scratches easily | 4 |
| observed in reflected or transmitted | |
| light. Almost complete removal of | |
| coating. | |

### Preparation of Surface Modified Silica Sol (Sol-1)

25.25 grams of A-174 and 0.5 gram of PROSTAB was added to the mixture of 400 grams of 20 nm diameter SiO₂ sol (“NALCO 2327”) and 450 grams of 1-methoxy-2-propanol in a glass jar with stirring at room temperature for 10 minutes. The jar was sealed and placed in an oven at 80° C. for 16 hours. Then, the water was removed from the resultant solution with a rotary evaporator at 60° C. until the solid content of the solution was close to 45 wt. %. 200 grams of 1-methoxy-2-propanol was charged into the resultant solution, and the remaining water was removed by using the rotary evaporator at 60° C. This latter step was repeated for a second time to further remove water from the solution. Finally, the concentration of total SiO₂ nanoparticles was adjusted to 45.84 wt. % by adding 1-methoxy-2-propanol to result in the SiO₂ sol containing surface modified SiO₂ nanoparticles with an average size of 20 nm.

### Preparation of Surface Modified Silica Sol (Sol-2)

5.95 grams of A-174 and 0.5 gram of 4-hydroxy-2,2,6,6-tetramethylpiperidine 1-oxyl (“PROSTAB”) was added to the mixture of 400 grams of 75 nm diameter SiO₂ sol (NALCO 2329) and 450 grams of 1-methoxy-2-propanol in a glass jar with stirring at room temperature for 10 minutes. The jar was sealed and placed in an oven at 80° C. for 16 hours. Then, the water was removed from the resultant solution with a rotary evaporator at 60° C. until the solid content of the solution was close to 45 wt. %. 200 grams of 1-methoxy-2-propanol was charged into the resultant solution, and the remaining water was removed by using the rotary evaporator at 60° C. This latter step was repeated for a second time to further remove water from the solution. Finally, the concentration of total SiO₂ nanoparticles was adjusted to 45.5 wt. % by adding 1-methoxy-2-propanol to result in the SiO₂ sol containing surface modified SiO₂ nanoparticles with an average size of 75 nm.

### Preparation of HardCoat Precursor (HC-1)

235.602 grams of Sol-1 and 72.0 grams of hexafunctional aliphatic urethane acrylate (“EBECERYL 8301”) were mixed. Then 3.6 grams of leveling agent (“TEGORAD 2500”) as an additive and 10.8 grams of difunctional alpha hydroxyketone (“ESACURE ONE”) as the photoinitiator and were added to the mixture. The mixture was adjusted to 12.0 wt. % in solids by adding 902 grams of 1-methoxy-2-propanol and 396 grams of 2-propanol and the hardcoat precursor HC-1 was provided.

### Preparation of HardCoat Precursor (HC-2)

235.602 grams of Sol-1 and 72.0 grams of tris (2-hydroxy ethyl) isocyanurate triacrylate (“SR368”) were mixed. Then 3.6 grams of leveling agent (“TEGORAD 2500”) as an additive and 10.8 grams of difunctional alpha hydroxyketone (“ESACURE ONE”) as the photoinitiator and were added to the mixture. The mixture was adjusted to 12.0 wt. % in solids by adding 902 grams of 1-methoxy-2-propanol and 396 grams of 2-propanol and the hardcoat precursor HC-2 was provided.

### Preparation of HardCoat Precursor (HC-3)

237.31 grams of Sol-1 and 72.0 grams of hexafunctional aliphatic urethane acrylate (“EBECRYL 8301”) were mixed. Then 10.8 grams of difunctional alpha hydroxyketone (“ESACURE ONE”) as the photoinitiator and were added to the mixture. The mixture was adjusted to 12.0 wt. % in solids by adding 835 grams of 1-methoxy-2-propanol and 437 grams of 2-propanol and the hardcoat precursor HC-3 was provided.

### Preparation of HardCoat Precursor (HC-4)

103.823 grams of Sol-1, 193.154 grams of Sol-2 and 72.0 grams of hexafunctional aliphatic urethane acrylate (“EBECRYL 8301”) were mixed. Then 3.6 grams of leveling agent (“TEGORAD 2500”) as an additive and 10.8 grams of difunctional alpha hydroxyketone (“ESACURE ONE”) as the photoinitiator and were added to the mixture. The mixture was adjusted to 12.0 wt. % in solids by adding 816.5 grams of 1-methoxy-2-propanol and 450.5 grams of 2-propanol and the hardcoat precursor HC-4 was provided.

### Comparative Example A (CE-A) and Examples 1 to 4 (EX-1 to EX-4)

CE-A was a bare APF-v4 reflective polarizer film with a thickness of 16.5 micrometer (obtained from 3M Company, Saint Paul, Minn.) was used as a substrate. No hardcoat was applied. EX-1, EX-2, EX-3 and EX-4 were each prepared by using the APF-v4 reflective polarizer film with a thickness of 16.5 micrometer as a substrate and then forming a 450 nm thick hardcoat using HC-1, HC-2, HC-3 and HC-4, respectively. The hardcoats of EX-1, EX-2, EX-3 and EX-4 were formed by SD gravure coater (obtained from OSG System Products Co., LTD, Aichi, Japan) at 200 line gravure bar and at a 120% wiping ratio and using a HT-10EY ROKI filter (obtained from ROKI Co., Ltd, Shizuoka, Japan) for on-line filtering. The coated films were fed into a three-zone oven. The three zones were equipped with a 30 Hz, 40 Hz and 40 Hz inverter fans, respectively. The actual temperature at zones 1, 2, and 3 were 59° C., 67° C., and 66° C., respectively. The line speed was set at 6 meters per minute. The UV power was set at 40% of 240 W/cm H-bulb. The oven was purged with nitrogen at an O₂ content of about 120-240 ppm. Web tension was 20/24/19/20 N (for a 250 mm web) at UV/Input/Oven/Wind, respectively. The resulting samples of CE-A, EX-1, EX-2, EX-3 and EX-4 were tested using methods described above. Table 2, below, summarizes the adhesion peel test data.

TABLE 2

| | | Deep cut | |
|---|---|---|---|
| Example | Shallow cut peel force | peel force (N/cm) | Scratch rating |
| EX-1 | No delamination | 0.409 | 0 |
| EX-2 | No delamination | 0.427 | 0 |
| EX-3 | No delamination | 0.988 | 0 |
| EX-4 | No delamination | 0.598 | 0 |
| CE-A | No delamination | 0.407 | 4 |

Foreseeable modifications of this disclosure will be apparent to those skilled in the art without departing from the scope and spirit of this invention. This invention should not be restricted to the embodiments that are set forth in this application for illustrative purposes.

1. An article comprising:
a reflective polarizer having a first major surface; and
exposed hardcoat on the first major surface, the exposed hardcoat comprising binder, wherein the binder comprises surfactant, and wherein the exposed hardcoat has a thickness not greater than 500 nanometers and has a scratch rating of not greater than 1 as determined by the Linear Abrasion Test in the Examples.

2. The article of claim 1, wherein the exposed hardcoat further comprises nanoparticles in a range from 40 to 95 weight percent, based on the total weight of the exposed hardcoat, and wherein the nanoparticles have an average particle diameter in a range from 2 nm to 100 nm.

3. The article of claim 2, wherein the ratio of average particle diameters of nanoparticles having an average particle diameter in the range from 2 nm to 20 nm to average particle diameters of nanoparticles having an average particle diameter in the range from 20 nm to 100 nm is in a range from 1:2 to 1:200.

4. The article of claim 2, wherein the nanoparticles include at least one of SiO₂, ZrO₂, or Sb doped SnO₂ nanoparticles.

5. The article of claim 2, to wherein the nanoparticles include modified nanoparticles.

6. The article of claim 1, wherein the binder comprises cured acrylate.

7. The article of claim 1 further comprising an absorbing polarizer, wherein, in order are, the absorbing polarizer, the reflective polarizer, and the exposed hardcoat.

8. The article of claim 1 further comprising pressure sensitive adhesive and an absorbing polarizer, wherein, in order are, the absorbing polarizer, the pressure sensitive adhesive, the reflective polarizer, and the exposed hardcoat.

9. The article of claim 7, further comprising a primer layer between the reflective polarizer and the exposed hardcoat.

10. The article of claim 1, wherein the reflective polarizer comprises a plurality of film layers, and where at least a portion of the film layers have a peel force between adjacent film layers of at least 0.2 Newton/25 mm as determined by the Peel Test in the Examples.

11. A method of making the article according to claim 2 comprising nanoparticles, the method comprising:
providing a reflective polarizer having a first major surface;
coating a mixture onto the first major surface, the mixture comprising at least one of acrylic, (meth)acrylic oligomer, or monomer binder in a range from 5 weight percent to 60 weight percent, wherein the binder comprises surfactant, and nanoparticles in a range from 40 to 95 weight percent, based on the total volume of the mixture, and wherein the nanoparticles have an average particle diameter in a range from 2 nm to 100 nm; and
curing the at least one of acrylic, (meth)acrylic oligomer, or monomer binder to provide the article.

12. The method of claim 11, wherein the curing includes actinic radiation.

13. A method of making the article of claim 1 not including nanoparticles, the method comprising:
providing a reflective polarizer having a first major surface;
coating at least one of acrylic, (meth)acrylic oligomer, or monomer binder onto the major surface, wherein the binder comprises surfactant; and
curing the at least one of acrylic, (meth)acrylic oligomer, or monomer binder to provide the article.

14. The method of claim 13, wherein the curing includes actinic radiation.
